(19) United States
(12) Patent Application Publication
(10) Pub. No.: US 2022/0194483 A1
(43) Pub. Date: Jun. 23, 2022

(54) APPARATUSES AND METHODS OF ATTACHING AN ADDITIVELY MANUFACTURED STRUCTURE TO A PROFILE

(71) Applicant: Divergent Technologies, Inc., Los Angeles, CA (US)

(72) Inventors: Richard Winston Hoyle, Clarkston, MI (US); Antonio Bernerd Martinez, El Segundo, CA (US); Mahesha Halasahalli Siddegowda, Los Angeles, CA (US)

(21) Appl. No.: 17/553,453

(22) Filed: Dec. 16, 2021

Related U.S. Application Data
(60) Provisional application No. 63/127,701, filed on Dec. 18, 2020.

(51) Int. Cl. B62D 27/02; B29C 65/00

(52) U.S. Cl. CPC B62D 27/023; B29C 66/8322

(57) ABSTRACT

Apparatuses and methods are provided for joining at least two structural components. A receiving structure including a mating profile having one or more tongues and grooves may be configured to contain at least one adhesive. A joint feature of a node structure may include a mating feature with a converging profile configured to mate with the mating profile of the receiving structure. One or more tongues and grooves may be present at the joint feature and configured to mate with corresponding tongues and grooves of the receiving structure.

### CROSS-REFERENCE TO RELATED APPLICATIONS

This application claims priority to U.S. Provisional Application No. 63/127,701 titled “ATTACHMENT METHOD OF AN ADDITIVE MANUFACTURED COMPONENT TO A HOLLOW PROFILE,” filed Dec. 18, 2020, which is assigned to the assignee hereof, and incorporated herein by reference in its entirety as if fully set forth herein.

### BACKGROUND

### Field

The present disclosure relates to apparatuses and methods for assembling structures, and more specifically relates to attaching additively manufactured components to profiles.

### Background

A vehicle such as an automobile, truck or aircraft is made of a large number of individual structural components joined together to form the body, frame, interior and exterior surfaces, etc. These structural components provide form to the automobile, truck or aircraft, and respond appropriately to the many different types of forces that are generated or that result from various actions like regular vehicle operations, accelerating and braking. These structural components also provide support. Structural components of varying sizes and geometries may be integrated in a vehicle, for example, to provide an interface between panels, extrusions, and/or other structures. Thus, structural components are an integral part of vehicles.

Modern automobile factories rely heavily on robotic assembly of structural components. However, robotic assembly of automobile components typically relies on the use of fixtures to securely retain the structural components during the assembly process. For example, in automobile factories, each part of the automobile that will be robotically assembled may require a unique fixture that is specific to that part. Given the large number of individual parts in an automobile that are robotically assembled, an equally large number of fixtures may be required, resulting in increased cost.

Three-dimensional (3-D) printing, which may also be referred to as additive manufacturing, is a process used to create 3-D objects, including structural components. The 3-D objects may be formed using layers of material based on digital model data of the object. A 3-D printer may form the structure defined by the digital model data by printing the structure one layer at a time. 3-D printed objects may be almost any shape or geometry.

3-D printed structures can include sub-components for various devices or apparatuses. The 3-D printed sub-components may be attached or connected to other subcomponents, including other 3-D printed sub-components, extruded subcomponents, or still other sub-components. For example, one 3-D printed component may be used to mate two or more other components together. The two or more other components may or may not be 3-D printed components.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Several aspects of apparatuses and methods including mating two structures will be described more fully hereinafter.

In various aspects, an apparatus may include a receiving structure having a hollow interior, the receiving structure having a mating profile cut into one or more surfaces of the receiving structure, and a node structure having a joint feature, in which the joint feature has a mating feature with a converging profile configured to mate with the mating profile of the receiving structure. The mating feature can include one or more portions containing adhesive for mating the receiving and node structures.

In one or more embodiments, the mating feature includes a first groove containing a structural adhesive and a second groove containing a UV adhesive. In one or more embodiments, the mating feature includes at least one window that receives electromagnetic radiation into the second groove. In one or more embodiments, the mating profile extends along a longitudinal axis, a latitudinal axis, or both a longitudinal and latitudinal axis of the receiving structure. In one or more embodiments, the mating profile of the receiving structure is cut by a laser or a water-jet.

In one or more embodiments, the joint feature includes a core having a converging profile. For example, the core can be solid. In one or more embodiments, the joint feature includes opposing surface layers on an end portion of the joint feature spaced a distance apart. For example, the opposing surface layers on the end portion of the joint feature extend beyond the core. In one or more embodiments, the joint feature includes an anti-rotation feature located at and engaging with an external surface of the receiving structure.

In one or more embodiments, the mating feature of the node structure includes one or more tongues and one or more grooves. In one or more embodiments, the node structure is additively manufactured.

In various aspects, an apparatus may include a receiving structure having a hollow interior, the receiving structure having a mating profile cut into one or more surfaces of the receiving structure, and a node structure having a joint feature, wherein the joint feature has a mating feature with a converging profile mated with the mating profile of the receiving structure. The mating feature can include one or more portions containing adhesive mating the receiving and node structures.

In one or more embodiments, the joint feature comprises a core having a converging profile. In one or more embodiments, the joint feature includes opposing surface layers on an end portion of the joint feature spaced a distance apart that are mated to the receiving structure. For example, the opposing surface layers on the end portion of the joint feature can extend beyond the core and overlap a surface of the receiving structure. In one or more embodiments, the node structure is additively manufactured.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of will now be presented in the detailed description by way of example, and not by way of limitation, in the accompanying drawings, wherein:

FIG. 1 illustrates a top perspective view of an example receiving structure.

FIG. 2 illustrates a top perspective view of an example receiving structure and an example joint feature of a node structure in an unmated configuration.

FIG. 3A illustrates a top perspective view of an example receiving structure and an example joint feature of a node structure in a mated configuration.

FIG. 3B illustrates a side perspective view of the example receiving structure and example joint feature of a node structure in a mated configuration of FIG. 3A.

FIG. 4 is a method flow of an example method for utilizing a mating of a receiving structure and a joint feature.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

In the field of additive manufacturing, or 3-D printing, there is a need for efficient and economical approaches for assembling a transport structure (e.g., an automobile chassis) that include mating of off-the-shelf structures with additively manufactured parts. The use of additive manufacturing in the context of joining two or more parts provides significant flexibility and cost saving benefits that enable manufacturers of mechanical structures and mechanized assemblies to manufacture parts with complex geometries at a lower cost to the consumer. For example, it is advantageous to have structure assembly that does not require numerous fixtures that are dependent on the chassis design. The structures may be, for example, nodes, tubes, extrusions, panels, pieces, parts, components, assemblies or subassemblies (e.g., including at least two previously joined structures) and the like. For instance, a structure or a part may be at least a portion or section associated with a vehicle, such as a vehicle chassis, panel, base piece, body, frame, and/or another vehicle component.

One important issue that has been encountered is how to enable various disparate parts or structures to more efficiently interconnect. One such technique as disclosed herein involves the use of additive manufacturing. More specifically, by utilizing additive manufacturing techniques to print unique parts for joining with off-the-shelf structures, it becomes simpler to join different parts and/or components in the manufacturing process. Such techniques can include deforming a portion of one part to conform to the internal shape of another. Additive manufacturing provides the ability to create complex internal shapes that were not previously possible using conventional manufacturing techniques.

A node is a structure that may include one or more interfaces used to connect to other structures (e.g., tubes, panels, etc.). Node structures may be produced using additive manufacturing (e.g., 3-D printing). Node structures can be added to other structures by robotic means. For example, a robot may be configured to directly hold a structure, e.g., using an end effector of a robotic arm, and to position and join that structure with another structure held by another robot during the assembly process. Structures intended for mating may have corresponding features, e.g., a first structure contains grooves and a second structure has tongues configured to mate with the grooves of the first structure. Adhesive may be added to the grooves in order to facilitate mating between the structures.

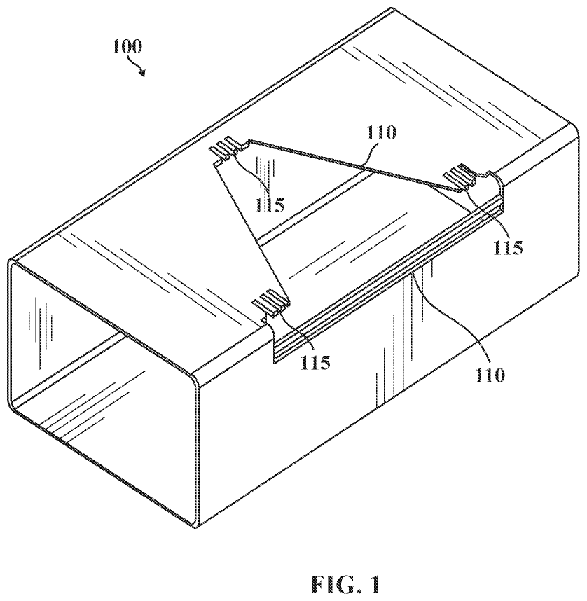

With reference now to FIG. 1, a receiving structure 100 is provided. Receiving structure 100 may be any type of structure having a defined profile, such as an extrusion or composite tube. In one or more embodiments, receiving structure 100 includes a hollow interior. The cross-sectional profile of the receiving structure can be any shape. For example, the cross-sectional profile of receiving structure 100 in FIG. 1 is square, but other cross-sectional profiles may be contemplated, including rectangular, circular, triangular, or other regular and irregular geometric shapes.

Material at a portion of one or more surfaces of receiving structure 100 is cut or removed from the receiving structure to define a mating profile 110. In one or more embodiments, mating profile 110 is created by laser cutting, water cutting, stamping, or other 2-D, 2.5-D, or 3-D cutting methods. In one or more embodiments, mating profile 110 extends along a longitudinal axis of the receiving structure. In one or more embodiments, mating profile 110 extends along a latitudinal axis of the receiving structure. In one or more embodiments, mating profile 110 extends along both the longitudinal and latitudinal axes of the receiving structure.

Mating profile 110 can be sized and shaped in any configuration in order to facilitate reception of another structure. For example, in FIG. 1, mating profile 110 has a tapered or converging profile that narrows from one end to another end as the mating profile extends transversely across the upper surface of the receiving structure 100 to create a trapezoidal mating profile. Other sizes and shapes of mating profile 110 can be contemplated, such as a mating profile that widens or diverges from one end to another end as the mating profile extends transversely across the receiving structure 100, a mating profile that maintains a consistent size from one end to another, or a mating profile that varies in widening and narrowing as the profile extends from one end to the other end. In one or more embodiments, mating profile 110 tapers to narrow, widens, or stays consistently wide from one end to another as the mating profile extends longitudinally across the receiving structure 100. In one or more embodiments, mating profile 110 narrows, widens, or stays consistently wide in both the longitudinal and transverse directions across receiving structure 100. The extent of the size and shape of mating profile 110 is not limited by the foregoing examples. Those skilled in the art recognize that other sizes and shapes of mating profile 110 may be contemplated as desired in order for the receiving structure 100 to receive structures of different sizes and shapes. For example, mating profile 110 can be variously shaped, including in the shapes of squares, triangles, rectangles, circles, ovals, diamonds, stars, or other shapes.

Mating profile 110 can be located at different portions of receiving structure 100 as necessary in order to receive and mate with a desired structure. For example, in one or more embodiments, mating profile 110 is cut into one or more surfaces of receiving structure, including a front surface, a rear surface, an upper surface, and/or bottom surface. The cut may be entirely through the surface, or through a portion of the surface. In one or more embodiments, mating profile 110 can be formed in one or more outer edges of receiving structure 100.

In one or more embodiments, mating profile 110 is designed to include retention features. Retention features can be, for example, one or more tongues and grooves 115. A tongue may be in the form of a projection, and a groove may be in the form of a recess. A tongue may consist of a single projecting segment, or may contain a plurality of segments spaced apart from each other (e.g., a comb, fork, or jagged shape). In one or more embodiments, a tongue may project from the mating profile 110 and include one or more grooves or openings within the projection capable of receiving another retention feature (e.g., a waffle or loop shape). A groove may consist of a single recess cut into the mating profile 110, or may consist of a plurality of recesses cut into the mating profile spaced apart from one another. The tongues or grooves may alternatively take other shapes. Mating profile 110 can include as many tongues and or grooves desired in order to mate or engage with corresponding tongues or grooves on a structure desired to be received by receiving structure 100.

In one or more embodiments, adhesive may be contained within or on tongues or grooves or portions thereof at the mating profile 110. In one or more embodiments, the adhesive is a structural adhesive (e.g., an epoxy adhesive). In one or more embodiments, the adhesive is a quick-cure adhesive having an increased cure rate upon exposure to electromagnetic radiation (e.g., ultraviolet (UV) radiation).

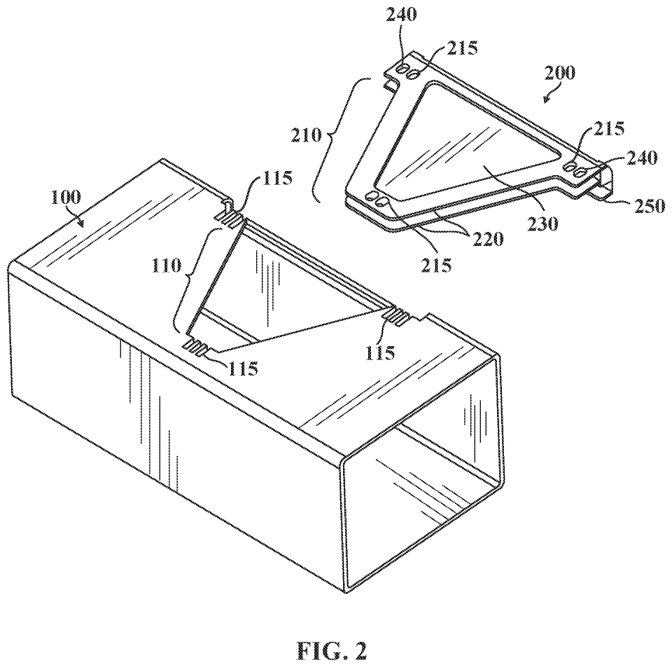

With reference now also to FIG. 2, receiving structure 100 and joint feature 200 are illustrated in an unmated configuration. Joint feature 200 may be an additively manufactured structure shaped to accept a particular type of component, e.g., receiving structure 100. Joint feature 200 may be manufactured as a standalone component, or may be manufactured as part of a larger additively manufactured component, such as a node structure (not shown). A node structure may be any 3-D printed part that includes features, such as joint feature 200, configured to accept or mate with a particular type of component (e.g., receiving structure 100). Such joint features may be co-printed with the node structure. In one or more embodiments, the joint feature 200 is located at an end of the node structure.

Joint feature 200 includes a mating feature 210. In one or more embodiments, mating feature 210 is disposed around the outer edges of joint feature 200. The mating feature 210 may be sized, shaped, and oriented to be received by the mating profile 110 of receiving structure 100. In one or more embodiments, the mating feature 210 and the mating profile 110 have complementary designs such that when the joint feature 200 is mated with the receiving structure 100, the outer surface of all of the mating feature 210 connects to the surfaces of the mating profile 110 at substantially the same time.

In one or more embodiments, joint feature 200 includes retention features. For example, the retention features can be one or more tongues and grooves 215. A tongue may be in the form of a projection, and a groove may be in the form of a recess. The tongues may contain a plurality of segments spaced apart from each other (e.g., a comb, fork, or jagged shape) or a plurality of openings (e.g., a waffle or loop shape). The tongues or grooves may alternatively take other shapes. Mating feature 210 can include as many tongues and or grooves 215 desired in order to mate or engage with complementary tongues or grooves 115 on receiving structure 100. For example, a tongue (or protrusion) of the mating feature 210 may be inserted into a groove (or recess) of mating profile 110.

In one or more embodiments, mating feature 210 is configured to engage the edges of mating profile 110 when the joint feature 200 and receiving structure are mated. For example, mating feature 210 can include opposing surface layers 220 on an end portion of the joint feature 200 spaced a distance apart such that when the joint feature 200 engages with the receiving structure 100, a portion of the opposing surface layers abut or overlap the surfaces of the receiving structure. For example, a portion of the opposing surface layers overlap a portion of the receiving structure 100 in at least one of the azimuthal (or horizon) plane and/or the elevational plane when the joint feature 200 is mated with the receiving structure.

In one or more embodiments, opposing surface layers 220 define a groove running along all, or a portion of, the outer edge of the mating feature 210. In one or more embodiments, opposing surface layers 220 define a gap between the upper and lower portions of the joint feature 200. When engaged with the receiving structure 100, the opposing surface layers 220 may abut the surfaces of the receiving structure by extending over and engaging one or more of the outer and inner surfaces of the mating profile 110. In other examples, the opposing surface layers 220 may abut the surfaces of the receiving structure 100 by engaging with the front surfaces of the mating profile 110.

In one or more embodiments, mating feature 210 may have a converging or tapering profile. That is, mating feature 210 may narrow in width toward an end of the joint feature 200. For example, mating feature 210 may narrow in width toward the portion that extends the furthest into the receiving structure 100 upon mating. Mating feature 210 can have variously shaped profiles, including a triangular, trapezoidal, diamond, semi-circular, rounded, convex, or other profile which narrows from one end to the other.

In one or more embodiments, mating feature 210 may have a diverging or broadening profile. That is, mating feature 210 may widen toward an end of the joint feature 200. For example, mating feature 210 may widen toward the portion that extends the furthest into the receiving structure upon mating. For example, mating feature 210 may have variously shaped profiles, including an inverted triangular, inverted trapezoidal, inverted diamond, inverted semi-circular, or inverted rounded profile, or a concave or other profile which broadens from one end to the other.

Mating feature 210 may also vary in height so as to correspond with height variations in receiving structure 100. For example, mating feature 210 may become thinner or thicker in a transverse or longitudinal direction. In one or more embodiments, one or both of the opposing surface layers 220 vary in height so as to correspond with the mating profile 110.

In one or more embodiments, one or more portions of mating feature 210 contain adhesive for mating the receiving structure 100 and joint feature 200. For example, adhesive can be contained at one or more tongues or grooves 215 of the mating profile. Different adhesive types, such as structural adhesives or quick-cure (e.g., UV) adhesives, may be contained at different tongues or grooves 215. As the number of grooves increases, the amount of bonding surface area increases, which may increase the securing nature of the mating feature 210.

In one or more embodiments, mating feature 210 is disposed about a core 230 of the joint feature. In one or more embodiments, the core 230 extends to the opposing surface layers 220.

As shown in FIG. 2, the core 230 can be a solid portion of the joint feature 200 having the same shape as the joint feature 200. For example, the core 230 may have a converging profile. However, the core 230 is not limited to being solid or the same shape as joint feature 200. For example, the core 230 can be a cut-out or removable portion of the joint feature so as to reduce weight of the joint feature or to permit access to the interior of the receiving structure when the structures are in a mated state. Further, the core 230 can be a different shape than the shape of the overall joint feature 200 so as to match structural desires or to facilitate mating with receiving structure 100.

In one or more embodiments, joint feature 200 includes one or more windows 240. Windows 240 can be translucent or transparent screens, or open apertures. Windows 240 can be oriented opposite a groove in the receiving structure 100 in which a quick-cure adhesive is located such that electromagnetic radiation can be emitted through the window to cure the quick-cure adhesive contained within the groove. Windows may also allow for the adhesive to be contained to minimize overflow or spill out when tongues are inserted and/or the structures are maneuvered.

In one or more embodiments, joint feature 200 includes an anti-rotation feature 250. Anti-rotation feature 250 can be used to prevent undesired rotation or movement of the joint feature 200 when the joint feature is mated with the receiving structure 100, as the anti-rotation feature is configured to engage with an external surface of the receiving structure. For example, the anti-rotation feature 250 can be an elongated tongue that when engaged with a groove of the receiving structure 100, prevents upward or downward rotation and/or prevents rotation in the plane of the tongue. In one or more embodiments, anti-rotation feature 250 mates with the receiving structure 100 in a direction perpendicular to the insertion direction.

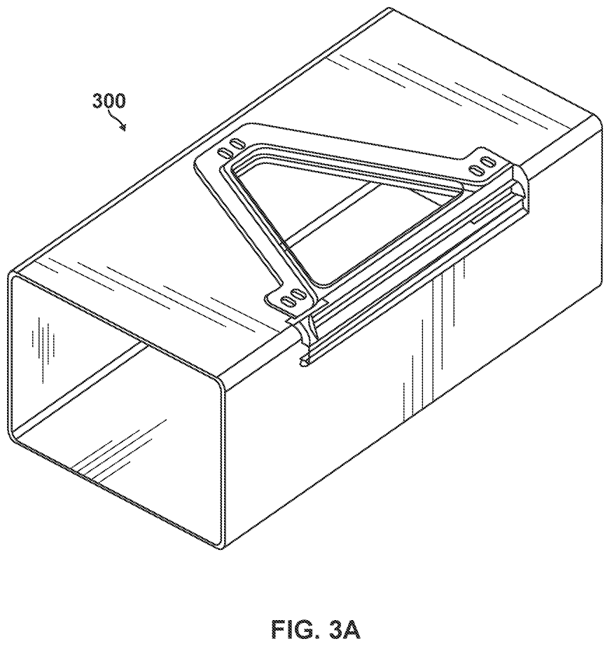

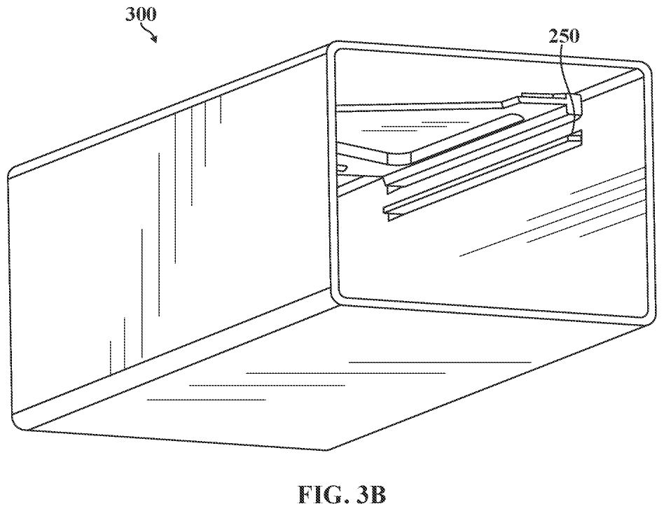

With reference now to FIGS. 3A-3B, an apparatus 300 is provided. Apparatus 300 includes receiving structure 100 and joint feature 200 in a mated state. As is shown, the mating feature 210 of the joint feature 200 is mated with mating profile 110 of the receiving structure 100 such that the cut-out portion of the receiving structure is fully concealed. One or more of the tongues and grooves 115 of the receiving structure engage with complementary tongues and grooves 215 of the joint feature 200. As shown by FIG. 3A, the direction of insertion of the joint feature 200 into the receiving structure 100 is parallel to the inserting surface defined by the mating profile 110.

When mated, the opposing surface layers 220 overlap a portion of one or more of the outer and inner surfaces of receiving structure 100 to ensure a snug fit between the structures. In this way, apparatus 300 recovers the structural strength lost by removing material from the receiving structure 100 to create the mating profile 110. Additionally, in the illustrated example, an anti-rotation feature 250 is mated with an additional groove of the receiving structure 100 to provide additional secure fit.

In one or more embodiments, the receiving structure 100 and joint feature 200 of apparatus 300 are mated using bosses, brackets, screws, bolts, staples, nails, fasteners, or other attachment features. Assembly can be performed manually or using automated (e.g., robotic attachment) methods.

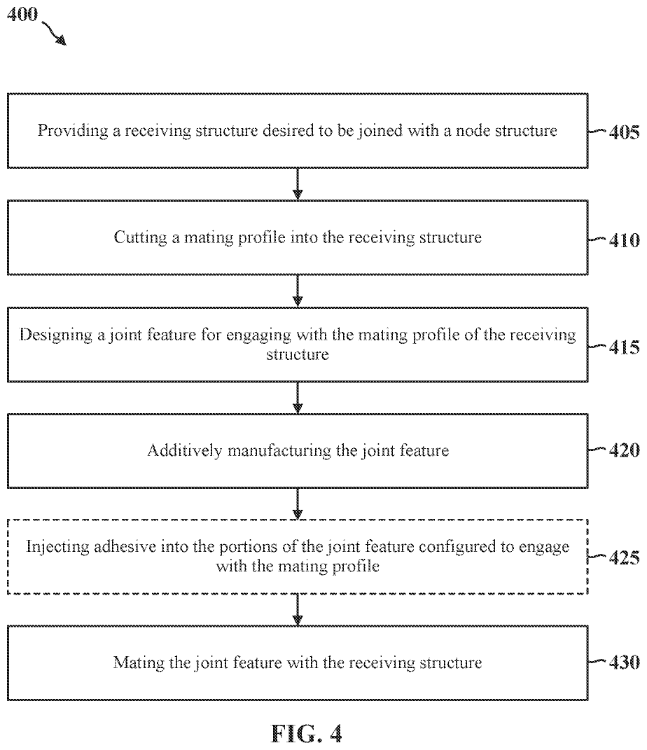

Referring now to FIG. 4, a method 400 for assembling an apparatus is provided. The method 400 may incorporate, for example, one or more elements of a receiving structure (e.g., receiving structure 100) and a joint feature (e.g., joint feature 200), or any other elements described herein.

At block 405, the method 400 provides a receiving structure that is desired to be joined with another structure. For example, the receiving structure can be an off-the-shelf component such as an extrusion or tube.

At block 410, the method 400 cuts a mating profile into the receiving structure. For example, the mating profile can be cut by laser or water-jet techniques. Further, the mating profile can be designed based on the desired structural results. For example, the mating profile can take into account the amount and location of material desired to be removed in order to maintain structural integrity of the receiving structure.

At block 415, the method 400 designs a joint feature for engaging with the mating profile of the receiving structure. The joint feature includes a mating feature configured to correspond with the mating profile of the receiving structure. The joint feature is designed to recover any structural strength lost from the material removal to create the mating profile of the receiving structure. In one or more embodiments, the joint feature is designed as a standalone component. In one or more embodiments, the joint feature is designed as part of a larger component. For example, the joint feature can be designed as part of a node structure.

At block 420, the method 400 additively manufactures the joint feature. For example, the joint feature may be 3-D printed by a conventional 3-D printer. In one or more embodiments in which the joint feature is a portion of a node structure, the joint feature and the node structure are co-printed.

At block 425, in one or more implementations, the method 400 optionally injects adhesive into the portions of the joint feature configured to engage with the mating profile. For example, adhesive can be injected into one or more tongues or grooves of the joint feature, between opposing surface layers, or into windows of the joint feature. The adhesive can be, for example, a structural adhesive or a quick-cure adhesive that is receptive to fast curing upon exposure to electromagnetic radiation such as UV light.

At block 430, the method 400 mates the joint feature with the receiving structure by engaging the mating feature of the joint feature with the mating profile of the receiving structure. In one or more embodiments, the joint feature and the receiving structure are mated using attachment features such as, for example, bosses, brackets, screws, bolts, staples, nails, or fasteners.

The previous description is provided to enable any person skilled in the art to practice the various aspects described herein. Various modifications to these exemplary embodiments presented throughout this disclosure will be readily apparent to those skilled in the art. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus comprising:
a receiving structure having a hollow interior, the receiving structure having a mating profile cut into one or more surfaces of the receiving structure; and
a node structure having a joint feature, wherein the joint feature has a mating feature with a converging profile configured to mate with the mating profile of the receiving structure,
wherein the mating feature includes one or more portions containing adhesive for mating the receiving and node structures.

2. The apparatus of claim 1, wherein the mating feature includes a first groove containing a structural adhesive and a second groove containing a quick-cure adhesive.

3. The apparatus of claim 2, wherein the mating feature includes at least one window that receives electromagnetic radiation into the second groove.

4. The apparatus of claim 1, wherein the mating profile extends along a longitudinal axis of the receiving structure.

5. The apparatus of claim 1, wherein the mating profile extends along a latitudinal axis of the receiving structure.

6. The apparatus of claim 1, wherein the joint feature is located at an end of the node structure.

7. The apparatus of claim 1, wherein the joint feature comprises a core having a converging profile.

8. The apparatus of claim 7, wherein the joint feature includes opposing surface layers on an end portion of the joint feature spaced a distance apart.

9. The apparatus of claim 8, wherein the opposing surface layers on the end portion of the joint feature extend beyond the core.

10. The apparatus of claim 7, wherein the core is solid.

11. The apparatus of claim 1, wherein the mating profile of the receiving structure includes one or more tongues and one or more grooves.

12. The apparatus of claim 1, wherein the mating feature of the node structure includes one or more tongues and one or more grooves.

13. The apparatus of claim 1, wherein the joint feature comprises an anti-rotation feature located at and engaging with an external surface of the receiving structure.

14. The apparatus of claim 1, wherein the mating profile of the receiving structure is cut by a laser or a water-jet.

15. The apparatus of claim 1, wherein the node structure is additively manufactured.

16. An apparatus comprising:
a receiving structure having a hollow interior, the receiving structure having a mating profile cut into one or more surfaces of the receiving structure; and
a node structure having a joint feature, wherein the joint feature has a mating feature with a converging profile mated with the mating profile of the receiving structure,
wherein the mating feature includes one or more portions containing adhesive mating the receiving and node structures.

17. The apparatus of claim 16, wherein the joint feature comprises a core having a converging profile.

18. The apparatus of claim 17, wherein the joint feature includes opposing surface layers on an end portion of the joint feature spaced a distance apart that are mated to the receiving structure.

19. The apparatus of claim 18, wherein the opposing surface layers on the end portion of the joint feature extend beyond the core and overlap a surface of the receiving structure.

20. The apparatus of claim 16, wherein the node structure is additively manufactured.
